(19) United States
(12) Patent Application Publication
(10) Pub. No.: US 2007/0275741 A1
(43) Pub. Date: Nov. 29, 2007

(54) METHODS AND SYSTEMS FOR IDENTIFYING SUSPECTED VIRUS AFFECTED MOBILE STATIONS

(75) Inventors: Sean X. Bian, Naperville, IL (US); Huixian Song, Narperville, IL (US)

Correspondence Address: FAY SHARPE/LUCENT, 1100 SUPERIOR AVE, SEVENTH FLOOR, CLEVELAND, OH, 44114, US

(73) Assignee: LUCENT TECHNOLOGIES INC., Murray Hill, NJ (US)

(21) Appl. No.: 11/456,188

(22) Filed: Jul. 8, 2006

Related U.S. Application Data
(63) Continuation-in-part of application No. 11/420,040, filed on May 24, 2006.

(51) Int. Cl. H04Q 7/20

(52) U.S. Cl. 455/466

(57) ABSTRACT

Methods and systems are presented for identifying suspected virus affected mobile stations in a wireless network, in which short message origination requests from mobile stations are received and analyzed to determine whether a mobile station is suspected of being affected by a virus, and the mobile station is notified if a virus is suspected. Once suspected, further mobile originated short messages are blocked until a user reactivates short messaging by contacting a service provider. One or more algorithms may be used in analyzing the mobile originated short messages from a particular mobile, where the algorithms may be modified by the service provider and/or by the subscriber.

### BACKGROUND OF THE INVENTION

The present invention is related to identifying mobiles suspected of being affected by a virus and for preventing short messages originating from virus-affected mobile stations and will be described with specific reference thereto, although it will be appreciated that the invention may have usefulness in other fields and applications. Inter-personal communications has advanced in recent years with continued development of communication technologies such as the Internet and wireless communications devices and networks. In particular, short message service (SMS) has become a regular means by which people communicate with one another on a daily basis, whether by computers at work and home or using short message capable mobile phones. Such communications devices, however, are sometimes subjected to being infected with so-called computer viruses, which can significantly alter the device operation, often to the detriment of the device user and other devices with which the affected device communicates. The viruses, moreover, may be transferred from an infected device to another device in a variety of ways, usually without notice to the user. For instance, many advanced applications and services offered for computers and wireless phones may be exploited by authors of such viruses, such as e-mail, downloading functions, transfer of pictures and other media, etc., wherein the authors of viruses typically design a virus to spread to as many devices as possible and to cause undesired operation of the affected devices. In this regard, although wireless communications devices (mobile stations) have only recently begun to provide many of these types of services, the number of mobile users affected by viruses is increasing. One undesirable manifestation of mobile stations affected by a virus is the unauthorized origination of short messages by the affected mobile, for instance, large numbers of short messages directed to other devices listed in the phone book directory stored in the mobile. Such short messages may result in increased billing for the subscriber whose virus affected mobile device originated the messages, as well as for the recipients of the messages. In addition, increase short message traffic of this nature occupies valuable bandwidth and resources of network operators and service providers, which could otherwise be applied to useful communications. Consequently, there is a need for improved systems and techniques for identifying virus affected mobile stations to inhibit generation of unwanted short messages in wireless communications networks.

### SUMMARY OF THE INVENTION

The following is a summary of one or more aspects of the invention provided in order to facilitate a basic understanding thereof, wherein this summary is not an extensive overview of the invention, and is intended neither to identify certain elements of the invention, nor to delineate the scope of the invention. The primary purpose of the summary is, rather, to present some concepts of the invention in a simplified form prior to the more detailed description that is presented hereinafter. The various aspects of the present invention relate to systems and methods for identifying suspected virus affected mobile stations and for mitigating unwanted short message traffic in wireless networks. Short message origination requests from mobile stations are analyzed to determine whether a mobile station is suspected of being affected by a virus, and the mobile station is notified if a virus is suspected, such as by sending a short message to the suspected mobile. Once a mobile is suspected, moreover, further mobile originated short messages may be blocked until a user reactivates short messaging by contacting a service provider. One or more algorithms may be used in analyzing the mobile originated short messages from a particular mobile, where the algorithms may be modified by the service provider and/or by the subscriber.

One or more aspects of the invention relate to a method for identifying suspected virus affected mobile stations in a wireless network. The method includes determining whether a mobile station is suspected of being affected by a virus based on one or more short message origination requests associated with the mobile station. The method also comprises selectively notifying the mobile station if a virus is suspected, which notification may involve sending a short message to the mobile station indicating that a virus is suspected. The method may further include blocking short messages originated by a suspected mobile station, notifying the suspected mobile station that short messages have been blocked, and allowing a user to reactivate mobile originated short messages and/or to selectively deactivate the determination of whether the mobile station is suspected of being affected by a virus. Moreover, the short message blocking may include sending a request to a home location register (HLR) associated with the mobile station to deactivate short messaging by the suspected mobile station so that the unwanted short messaging does not continue when the mobile roams and registers with a new switching element.

The determination of whether a mobile station is suspected of being affected by a virus may comprise evaluating mobile originated short messages according to an algorithm using one or more thresholds or parameters stored in an HLR, VLR, or other subscriber database. In one embodiment, the algorithm includes comparing a number of short messages originated by the mobile station within a given time interval to a threshold, where the threshold may be adjusted by a subscriber or user, or may be changed by a service provider. In another example, a potential virus may be suspected when the mobile station repeatedly attempts to send short messages of the same length or the same content to a list of called parties within a given time interval. In this regard, the service provider in certain implementations may increase or decrease the virus detection threshold parameters according to time of day, day of the week, holidays, current mobile location, etc., in order to accommodate known high usage time periods for short messaging, while selectively detecting unusually high mobile originated short messaging during other times. The user may likewise raise the thresholds or adjust the time windows or other parameters to allow increased short messaging for upcoming events, such as the birth of a child, graduations, weddings, etc., and may even deactivate the virus detection service for a time to allow unlimited short messaging. In this manner, the invention may provide for a highly desirable subscription based service in wireless communications calling plans that inhibit the above mentioned shortcomings of virus initiated short messages to thereby benefit subscribers and recipients of unwanted short messages, as well as service providers.

Further aspects of the invention provide a method for inhibiting unwanted short messages in a wireless network. The method comprises determining whether a mobile station is suspected of being affected by a virus based on one or more short message origination requests associated with the mobile station, and blocking short messages originated by the mobile station if a virus is suspected. The method may also include selectively notifying the suspected mobile station that short messages have been blocked, such as by sending a short message to the mobile station indicating that mobile originated short messages have been blocked, as well as allowing the mobile user to reactivate mobile originated short messages.

Other aspects of the invention relate to a system for identifying suspected virus affected mobile stations in a wireless network, including a switching element in the network that receives short message origination requests from the mobile stations registered with the switching element, and a subscriber database associated with the switching element that stores records related to a mobile station registered with the switching element. The switching element may be a mobile switching center (MSC) in one example, which determines whether the mobile station is suspected of being affected by a virus based on one or more short message origination requests received by the switching element from the mobile station, and selectively notifies the mobile station if a virus is suspected. The switching element, moreover, may selectively block short messages originated by the mobile station if a virus is suspected, for example, by sending a request to an HLR to deactivate short messaging by the suspected mobile station. Thus configured, the systems of the invention can effectively prevent high network traffic associated with SMS originated from virus-affected subscribers, and may further advantageously notify the subscriber by sending a short message to the subscriber to indicate that the mobile might be affected by virus and its short message origination service is blocked so that the subscriber may remove the virus from the mobile and contact the service provider to reactivate SMS functions. In this manner, the user will learn of the potential virus infection long before the monthly service bill arrives, and prior to causing unwanted SMS to be sent to parties on the subscriber's phone book listing.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages, and novel features of the invention will become apparent from the following detailed description of the invention when considered in conjunction with the drawings. The present invention may be embodied in the construction, configuration, arrangement, and combination of the various system components and acts or events of the methods, whereby the objects contemplated are attained as hereinafter more fully set forth, specifically pointed out in the claims, and illustrated in the accompanying drawings in which:

FIG. 1 is a high level schematic diagram illustrating an exemplary telecommunications system with one or more systems for identifying virus affected mobiles and blocking associated mobile originated short messages in accordance with one or more aspects of the present invention; and

FIG. 2 a flow diagram illustrating an exemplary method according to further aspects of the invention.

### DETAILED DESCRIPTION

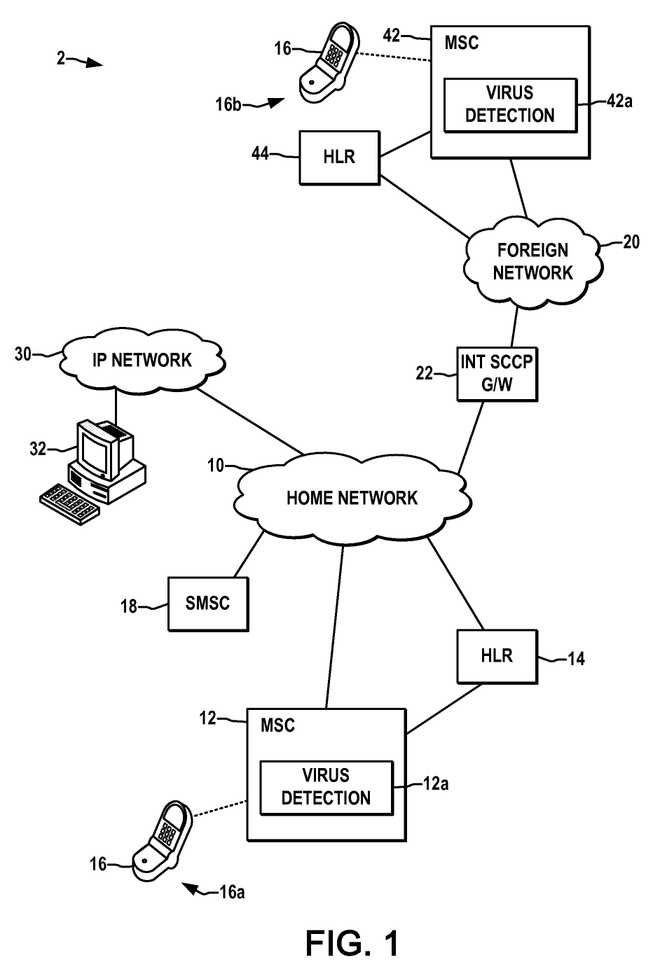

Referring now to the figures, wherein the showings are for purposes of illustrating the exemplary embodiments only and not for purposes of limiting the claimed subject matter, FIG. 1 provides a view of a communications system 2 into which the presently described embodiments may be incorporated or in which various aspects of the invention may be implemented. Several embodiments or implementations of the various aspects of the present invention are hereinafter illustrated and described in conjunction with the drawings, wherein like reference numerals are used to refer to like elements throughout and wherein the figures are not necessarily drawn to scale. The exemplary telecommunications system 2 includes various operationally interconnected networks of various topologies, including a home network 10 connected to a foreign network 20 via a gateway 22 and in which various messages may be exchanged and operated on. The various network elements of the networks 10 and 20 are in general operatively coupled to provide mobile telecommunications in a known manner between mobile station 16 and other communications devices, whether mobile or otherwise, wherein the exemplary mobile station 16 is illustrated in two exemplary locations indicated as 16a and 16b in FIG. 1 for purposes of illustrating various aspects of the invention, and any number of such mobile stations, whether mobile phones, PDAs, portable computers, etc. may be served by the networks 10, 20 of the system 2. The wireless networks 10 and 20, moreover, may provide for exchange of any type of messages, such as SS7 MAP messages in one possible example, wherein the networks 10, 20 each include one or more switching elements such as mobile switching centers (MSCs) 12 and 42, respectively, by which mobile station 16 can communicate with other devices.

The first network 10 in FIG. 1 is indicated as a home network with which the mobile 16 is subscribed for telecommunications services including phone services and short message services (SMS), where the exemplary mobile 16 is registered with a home MSC 12 associated with the home network 10 and communicates therewith when in the illustrated location 16a. The home MSC 12 is operatively associated with a home location register (HLR) 14 including a subscriber database in which subscriber profile and service information are stored, including one or more parameters associated with a user's subscription to virus detection/notification and SMS blocking services described herein. The home MSC 12, moreover, includes a virus detection application 12a providing these services for subscribers communicating via the MSC 12. The network 10 also provides one or more short message service centers (SMSCs) 18, wherein it will be appreciated that the system 2 may include any number of MSCs 12, 42, HLRs 14, 44, SMSCs 18, visitor location registers VLRs, as well as base station systems, base station controllers, etc., and other network elements (not shown) for implementing mobile telecommunications and short messaging functionality. The home network 10 is operatively coupled to one or more foreign networks 20 via the INT SCCP gateway 22 providing message exchange between the networks 10 and 20 whereby mobile communications can be achieved between a mobile phone or device 16 located in one network and another mobile communications device in the other network, wherein the home network 10 may be coupled through suitable gateways/interfaces with any type of foreign network 20 that employs any suitable type or form of messaging protocol(s).

The switching elements 12, 42 may be any suitable mobile switching or call control elements such as MSCs or others for performing normal switching and call control functions for mobile calls to and from mobiles 16 and/or other telephone and data systems, with associated HLRs 14, 44 and VLRs (not shown), where the HLRs generally implement subscriber databases used for storage and management of customer subscriptions and service profiles to facilitate routing calls to and from indicated subscribers, and VLRs provide a database storage and access functionality with respect to temporary information about roaming subscribers such that the MSCs 12, 42 can service visiting (roaming) and non-visiting mobiles. The switching elements 12, 42, moreover, can be any suitable hardware, software, combinations thereof, etc., which are operatively coupled with the networks 10, 20 of the system 2 in order to provide call service functionality as is known, including but not limited to routing and control functions, and the two illustrated MSCs 12 and 42 may be different or may be of the same or similar constitution.

In addition, the illustrated MSC switching elements 12, 42 include virus detection applications 12a, 42a, providing the functions illustrated and described herein for identifying mobiles suspected of being affected with a virus based on mobile originated SMS requests, and providing the notification and SMS blocking features described further below. The switching elements 12, 42, HLRs 14, 44, and associated VLRs and SMSCs 18 and the functionality thereof may be implemented in integrated entities or may be distributed across two or more entities in the system 2, for instance, where the elements 12 and 14 (and elements 42 and 44) may themselves be integrated with one another or separate. The exemplary MSCs 12, 42, moreover, preferably include memory and processing elements (not shown) for storing and executing software routines for processing and switching calls as well as for providing various call features to calling or called parties, and are generally operative with any suitable circuit, cell, or packet switching and routing technologies, including but not limited to Internet Protocol (IP) and Asynchronous Transfer Mode (ATM) technologies, etc., and are operatively interconnected by bearer and control traffic links (not shown) to accommodate exchange or transfer of bearer traffic (e.g., voice, video, or image data, etc.) as well as control traffic, wherein such links may be logical links implemented, for example, as T1 carrier, optical fiber, ATM links, wireless links, and the like.

The home network 10, moreover, is also operatively coupled with an Internet Protocol (IP) network or other packet-based network 30 for providing communications with one or more IP-based devices in the system 2, such as a computer 32, wherein the IP-based network 30 may include suitable IP gateway elements (not shown) coupling the packet-switched IP network 30 with the wireless home network 10 to provide call processing, data transfer, and other services including short messaging (SMS) services between IP-based devices 32 and the exemplary mobile device 16 and other devices associated with the network 10. The user of the exemplary mobile 16, moreover, can subscribe to various wireless services via the mobile 16 or through the internet via the computer 32 and the IP network 30 so as to subscribe to the virus detection, SMS blocking, and/or notification services described herein, and can further toggle the service on or off at any time via the computer 32 or via the phone 16, and may also adapt or modify parameters such as threshold values, etc., associated with the service, as described further below. Moreover, the user can contact the associated service provider via the mobile 16 or the computer 32 to reactivate SMS services once a suspected virus has been identified by the virus detection applications 12a, 42a. The various exemplary networks 10, 20, and 30 thus provide communicative connection of various communications devices and network elements allowing various telephones, mobile units, computers, digital assistants, etc. to communicate with one another for exchange or transfer of voice and/or video, short messages, and other data or information therebetween, wherein the communications system 2 generally can include any number of wireless, wireline, and/or packet-switched networks, and wherein only a few exemplary elements are illustrated in FIG. 1 for purposes of description of the concepts of the invention without obscuring the various features and aspects thereof.

The MSCs 12, 42 are interoperable with various forms of mobile stations 16, wherein any form of user equipment or mobile stations 16 may interface with the system 2 via MSCs 12, 42 and networks 10, 20, 30 for placing or receiving calls, for example, wireline or Plain-Old-Telephone-Service (POTS) phones communicating via a PSTN coupled with the system 2, mobile communication devices such as the illustrated mobile phone 16 and/or personal digital assistants (PDAs), pagers, computers with wireless interfaces, or other wireless devices communicating via one or more of the MSCs 12, 42, and IP-based devices, such as computers 32, VoIP phones, etc. interacting via the IP network 30. The operative coupling of the wireless mobile station 16 with the MSCs 12, 42 may be of any suitable form, for example, including base station system (BSS, not shown) equipment providing radio-related functions, where the BSSs preferably comprise base station controllers (BSCs) and base transceiver stations (BTSs) to transfer voice and data traffic between the mobile station 16 and the MSCs 12, 42. Moreover, the applications 12a, 42a can be any suitable combination of hardware, software, logic, etc., whether unitary or distributed, whereby the various virus detection, SMS blocking, and user notification features or aspects of the applications and the associated parameters stored in the subscriber databases 14, 44 and/or VLRs can be accessed for programming via the computer 32 or other device (including the mobile 16) which is operatively coupled with the home network 10 for adaptation, programming, updating, etc. by a user and/or by a service provider for configuring or adjusting one or more parameters associated with the features described herein.

The virus detection application 12a of the home MSC 12 operates to determine whether a particular mobile station 16 is suspected of being affected by a virus through analysis of SMS origination requests initiated by the mobile 16, and for identified suspect mobiles 16, the MSC 12 selectively notifies the suspect mobile 16 that it may be infected, and also operates to block further SMS origination for the subscriber, subject to having SMS service reactivated by the user upon contacting the service provider, wherein the second illustrated MSC 42 operates in similar fashion with respect to mobiles currently being served thereby. In this manner, the MSCs 12, 42 and the applications 12a, 42a provide advance warning of possible virus infection of a mobile 16, whether the virus is detected when at location 16a (being served by the home MSC 12) or when roaming (being served by the foreign network MSC 42). In application, the virus detection service can thus mitigate the amount of unwanted SMS traffic in the system 2 and also reduce the likelihood of excessive SMS charges to the subscriber operating mobile 16 or to recipients on the subscriber's phone number list. The virus detection/SMS blocking feature, moreover, is a subscriber-based service in the illustrated implementation, whereby the activation of the service and the parameters associated therewith are stored in the subscriber database of the home HLR 14 and transferred to a VLR or other database associated with a serving MSC 42 when the subscriber's mobile 16 roams (e.g., to location 16b in FIG. 1). Thus, once the user device 16 registers in or with an MSC 12, 42 supporting the application 12a, 42a, the feature information is passed from the home HLR 14 to the corresponding MSC 12, 42 in the mobile's profile during registration.

In the home network 10, the MSC 12, the application 12a, and the HLR database 14 constitute an exemplary system for identifying suspected virus affected mobile stations, wherein the MSC 42, application 42a and associated VLR or HLR 44 thereof constitute a similar system with respect to devices operating in the foreign network 20. With respect to the home system, the MSC switching element 12 receives short message origination requests (e.g., MAP SMS messages such as MAP FW_SMS_MO messages or other mobile originated SMS messages in any suitable protocol) from mobile stations such as mobile 16 registered with the switching element 12 when at location 16a, wherein the subscriber record stored in the HLR subscriber database 14 includes records related to the mobile station 16 and the subscribed services thereof and parameters related to the virus detection service used by the application 12a.

The MSC switching element 12 employs the application 12a to determine whether the mobile station 16 is suspected of being affected by a virus based on one or more short message origination requests received by the MSC 12 from the mobile 16, and selectively notifies the mobile station 16 if a virus is suspected. In the illustrated implementation, the service application 12a can provide this virus notification in any suitable form, such as by sending the mobile 16 a short message (e.g., a mobile terminated SMS message) indicating that a virus is suspected. In addition, the application 12a may be configured to selectively block short messages originated by the mobile station 16 if a virus is suspected, thereby preventing further outgoing short messages from being sent through the network 10 by the suspected mobile 16 while registered with the home MSC 12. In this regard, the exemplary application 12a also sends a request to the HLR 14 to deactivate short messaging by the suspected mobile station 16, so that mobile originated SMS will be prevented if the mobile 16 roams and registers with a different MSC (e.g., MSC 42 at location 16b in FIG. 1). Furthermore, the MSC 12 may also indicate by a short message to the mobile 16 that mobile originated SMS services has been blocked or suspended, either in the same notification regarding the virus detection or in a separate SMS message, wherein any such notification(s) may include other descriptive information, such as instructing the user to verify or remove the virus or instructions on how to reactivate SMS services (e.g., number/website of service provider) so the subscriber can initiate SMS reactivation after ensuring the mobile 16 is virus-free.

In the system of FIG. 1, moreover, the switching element 12 evaluates the short messages originated by the mobile station 16 according to an algorithm in the application 12a using service parameters stored in the subscriber database 14, which parameters can be modified by a service provider and/or by the subscriber (e.g., via the mobile station 16 and/or via the internet and computer 32), so as to respectively adjust one or more detection parameters or thresholds used in the analysis algorithm. Similarly, the virus detection application 42a in the MSC 42 employs an algorithm to analyze SMS originated by the mobile 16 when visiting the foreign network 20 in location 16b. In one possible embodiment, the MSC 12 and the application 12a thereof employ one or more thresholds or parameters stored in the subscriber database 14 for the evaluation, including comparing the number of mobile originated SMS messages from the mobile 16 within a given time interval, which may be any value in seconds, hours, days, etc., to a threshold value, where the threshold may be adjusted by a subscriber or user, and/or may be changed by the associated service provider. This form of testing may be employed alone or in combination with other tests, such as determining whether the mobile station 16 has repeatedly attempted to send SMS messages of the same or similar length or content to an identifiable group of destinations, such as called parties stored in a phone book listing within the mobile 16 within a given time interval.

The thresholds and other parameters used in the analysis algorithm may be dynamic, such as varying thresholds according to one or more temporal and/or geographic criteria, where the adaptation of the parameters(s) may be automated or manual or combinations thereof. In one example, the service provider may automatically or manually increase or decrease the virus detection threshold parameters depending on the time of day, the day of the week, holidays, the current location of the mobile, etc., in order to accommodate known high usage time periods and/or locations for short messaging, while selectively detecting unusually high mobile originated short messaging during other times or at other places. For instance, it may be known that users often send many SMS messages at work during work hours, but typically send few or none while at a particular vacation destination or from midnight to 6 A.M. In another example, it may be known that users typically send greetings via SMS messaging during new years or other popular holidays, whereby the algorithm can be adapted through threshold adjustments to more precisely ascertain whether a large number of mobile originated SMS truly indicates the effects of a virus in the mobile 16 or instead correlates to predictable user behavior. In this respect, the service provider may adjust the thresholds or other parameters periodically or in a generally continuous fashion through manual and/or automatic changes, where the adjustment may be at least partially based on stochastics, Bayesian logic, fuzzy logic, neural networks, or other predictive and/or adaptive learning techniques. Similarly, the subscriber may modify the thresholds or other parameters to allow increased short messaging for known upcoming events, such as anticipated child births, family functions, vacations, weddings, etc., and may further be allowed by the service to deactivate the virus detection service for a time to allow essentially unlimited short messaging.

In this manner, the virus detection service advantageously provides early indication to subscribers as to whether or not their mobile 16 may be affected by a virus, thereby allowing the subscriber to attend to remedying the situation before adverse effects are experienced. Thus, for instance, the user may discover and remove a virus from the mobile before incurring costs or harm associated with potential virus spreading to other user equipment owned by the subscriber, co-workers, friends, family, etc. Furthermore, the service may affirmatively block outgoing SMS once the virus has been detected, whereby the costs associated with subsequent adverse SMS messages can be avoided or mitigated. This, in turn, benefits the subscriber, the targeted recipients of such unwanted SMS messaging, and also the owners and operators of the wireless system 2, wherein the resources of the system 2 are freed from the expense and resources that would otherwise be dedicated for transferring undesired (e.g., virus initiated) SMS messages.

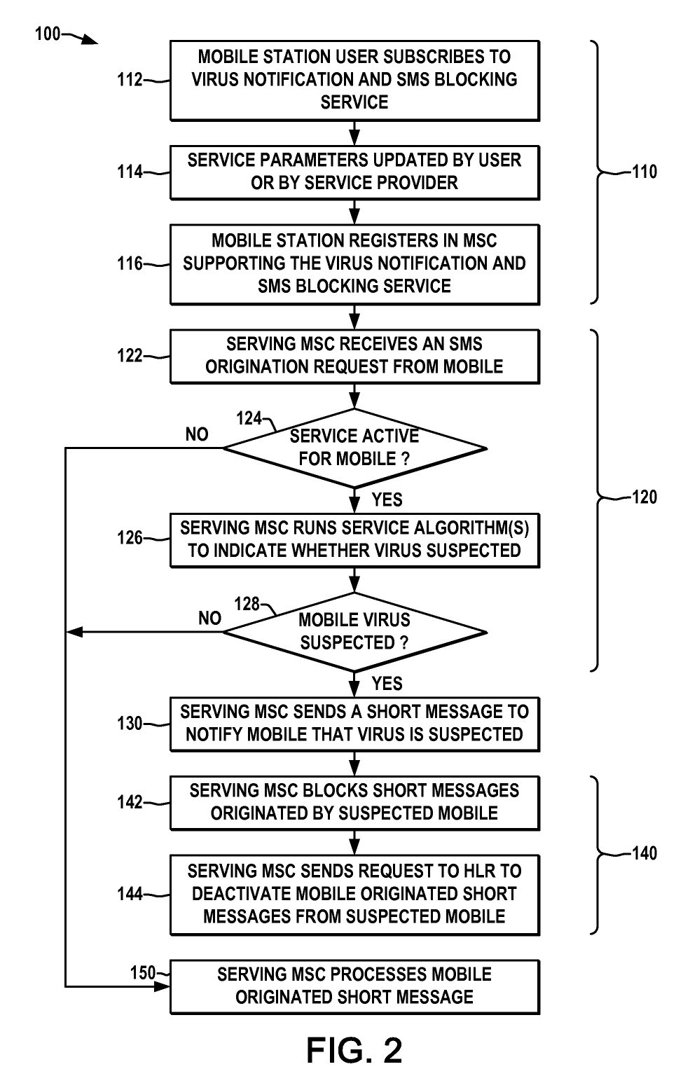

FIG. 2 illustrates an exemplary method 100 for inhibiting unwanted short messages and for detecting and notifying a subscriber of a suspected virus in a wireless network in accordance with various aspects of the invention. While the exemplary method 100 is illustrated and described hereinafter in the form of a series of acts or events, it will be appreciated that the various methods of the invention are not limited by the illustrated ordering of such acts or events except as specifically set forth herein. In this regard, except as specifically provided in the claims, some acts or events may occur in different order and/or concurrently with other acts or events apart from those acts and ordering illustrated and described herein, and not all illustrated steps may be required to implement a process or method in accordance with the present invention. The illustrated method 100 and other methods of the invention may be implemented in hardware, software, or combinations thereof, in order to provide the described functionality, wherein these methods can be practiced in hardware and/or software of the above described switching elements 12, 42, including the applications 12a, 42a, thereof, or other forms of logic, hardware, or software in any single or multiple entities operatively associated with a communications system or a network thereof, wherein the invention is not limited to the specific applications and implementations illustrated and described herein.

In one aspect of the invention, the method 100 involves identifying suspected virus affected mobile stations based on one or more short message origination requests associated with the mobile station 16 and providing corresponding notification to the user or subscriber via a short message to the mobile. In other aspects of the invention, the exemplary method 100 provides for inhibiting unwanted short messages in a wireless network by determining whether a mobile station is suspected of being affected by a virus, and blocking short messages originated by the mobile station if a virus is suspected. In the exemplary method 100, moreover, the services are subscription-based, wherein the subscription is established and selectively modified at 110. At 112, the mobile station user subscribes to the virus notification and SMS blocking service, and thereafter one or more parameters associated with the services (e.g., thresholds, etc.) may be modified or updated by the user and/or by the service provider at 114. It is noted at this point that such adaptation or parameter modification by users and/or service providers can occur at any time asynchronously with respect to the mobile originated SMS messaging and virus detection/notification/blocking events, wherein the exemplary depiction in FIG. 2 is merely an example for illustrating these features and no specific ordering of acts or events should be inferred therefrom. The mobile 16 then registers with an MSC or other switching element of a wireless network at 116 which supports the subscribed service.

At 120, the mobile station 16 attempts to originate one or more short messages while registered with the currently serving switching element (e.g., MSC), wherein the serving MSC receives an SMS origination request from the mobile 16 at 122. The switching element then makes a determination at 124 as to whether the service is currently activated for the requesting mobile 16, and if not (NO at 124), the process 100 proceeds to 150 in FIG. 2, with the serving MSC processing the mobile originated short message according to the normal procedure, for instance, using an associated SMSC 18 in FIG. 1 to terminate the SMS message to the indicated destination. Otherwise (YES at 124), the serving MSC evaluates the SMS originated by the mobile 16 at 126 by running one or more tests or service algorithms based on the mobile originated SMS, and makes a determination at 128 as to whether the mobile is suspected of being affected by a virus. If not (NO at 128), the method 100 proceeds to process the mobile originated SMS normally at 150 as described above, and otherwise (YES at 128), and notifies the mobile 16 by sending a short message at 130 indicating that the mobile may be virus affected and optionally that outgoing SMS will be blocked. Any suitable criteria or algorithms and associated thresholds or other parameters may be used in deciding whether a virus is suspected at 126, 128, for example, including the number of SMS originations in a given time interval provisioned on the serving MSC, whether the mobile 16 has attempted to repeatedly send the same or similar short messages to a group of destinations, etc., as described above.

In the illustrated implementation, moreover, a single SMS message is sent by the serving MSC at 130 to notify the mobile 16 that both a virus is suspected and that mobile originated SMS will be blocked, although individual SMS notifications could alternatively be provided or the notification at 130 could specify only suspected virus or blocked SMS information. The serving MSC in the illustrated embodiment blocks the mobile originated SMS for the suspected mobile 16 at 142 and further sends a request to the associated HLR 14 at 144 to deactivate mobile originated SMS so that upon subsequent registration with another MSC at another location, the mobile 16 will still be prevented from originating outgoing short messages. Once the suspected virus condition has been indicated to the user, he or she may then inspect or test the mobile to ascertain whether indeed a virus exists on the suspected mobile 16, and may take any appropriate remedial actions. Moreover, the user of the mobile 16 may then contact service provider to reactivate the mobile originated short message service, preferably after ensuring the mobile is not (or no longer) affected by a virus. Furthermore, as discussed above, the user and/or the service provider may manually or automatically adjust or modify one or more parameters employed in the virus detection at 110, wherein the updated service parameters are provided to the currently serving MSC upon registration as part of the subscriber profile information obtained from the home HLR 14, thereby allowing the service to be tailored to suit the subscriber's desired virus protection.

Although the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A method for identifying suspected virus affected mobile stations in a wireless network, the method comprising:
receiving short message origination requests in a switching element of the network from mobile stations registered with the switching element;
determining whether a mobile station is suspected of being affected by a virus based on one or more short message origination requests associated with the mobile station; and
selectively notifying the mobile station if a virus is suspected.

2. The method of claim 1, wherein selectively notifying the mobile station if a virus is suspected comprises sending a short message to the mobile station indicating that a virus is suspected.

3. The method of claim 1, further comprising blocking short messages originated by the mobile station if a virus is suspected.

4. The method of claim 3, further comprising notifying the suspected mobile station that short messages have been blocked.

5. The method of claim 3, wherein blocking mobile originated short messages originated by the suspected mobile station comprises sending a request to a home location register associated with the mobile station to deactivate short messaging by the suspected mobile station.

6. The method of claim 3, further comprising allowing a user of the mobile station to reactivate mobile originated short messages.

7. The method of claim 1, wherein determining whether a mobile station is suspected of being affected by a virus comprises evaluating short messages originated by the mobile station according to an algorithm.

8. The method of claim 7, wherein the algorithm comprises comparing a number of short messages originated by the mobile station within a given time interval to a threshold.

9. The method of claim 7, wherein the algorithm comprises determining whether the mobile station has repeatedly sent short messages of the same length or the same content to a list of called parties within a given time interval.

10. The method of claim 7, further comprising allowing a service provider to modify the algorithm.

11. The method of claim 7, further comprising allowing a user of the mobile station to modify the algorithm.

12. The method of claim 1, further comprising allowing a user of the mobile station to selectively deactivate the determination of whether the mobile station is suspected of being affected by a virus.

13. A method for inhibiting unwanted short messages in a wireless network, the method comprising:
determining whether a mobile station is suspected of being affected by a virus based on one or more short message origination requests associated with the mobile station; and
blocking short messages originated by the mobile station if a virus is suspected.

14. The method of claim 13, further comprising selectively notifying the suspected mobile station that short messages have been blocked.

15. The method of claim 14, wherein selectively notifying the mobile station comprises sending a short message to the mobile station indicating that mobile originated short messages have been blocked.

16. The method of claim 13, further comprising allowing a user of the mobile station to reactivate mobile originated short messages.

17. The method of claim 13, wherein determining whether a mobile station is suspected of being affected by a virus comprises evaluating short messages originated by the mobile station according to an algorithm.

18. The method of claim 17, wherein the algorithm comprises comparing a number of short messages originated by the mobile station within a given time interval to a threshold.

19. The method of claim 17, wherein the algorithm comprises determining whether the mobile station has repeatedly sent short messages of the same length or the same content to a list of called parties within a given time interval.

20. The method of claim 13, further comprising allowing a service provider or a user of the mobile station to modify the algorithm.

21. A system for identifying suspected virus affected mobile stations in a wireless network, comprising:
a switching element operatively coupled with the wireless network to receive short message origination requests from mobile stations registered with the switching element; and
a subscriber database associated with the switching element and storing records related to a mobile station registered with the switching element;
wherein the switching element determines whether the mobile station is suspected of being affected by a virus based on one or more short message origination requests received by the switching element from the mobile station, and selectively notifies the mobile station if a virus is suspected.

22. The system of claim 21, wherein the switching element is a mobile switching center.

23. The system of claim 21, wherein the switching element selectively blocks short messages originated by the mobile station if a virus is suspected.

24. The system of claim 23, wherein the switching element sends a request to a home location register associated with the mobile station to deactivate short messaging by the suspected mobile station.

25. The system of claim 21, wherein the switching element evaluates short messages originated by the mobile station according to an algorithm using service parameters stored in the subscriber database.

26. The system of claim 21, wherein the service parameters can be modified by a service provider.

27. The system of claim 21, wherein the service parameters can be modified by a user of the mobile station.
